(19) United States
(12) Patent Application Publication
(10) Pub. No.: US 2025/0211942 A1
(43) Pub. Date: Jun. 26, 2025

(54) DEVICE, METHOD AND SYSTEM FOR ANALYZING VIDEO FROM CAMERAS FOR TRACKING AND ACCESS AUTHORIZATION

(71) Applicant: MOTOROLA SOLUTIONS, INC., Chicago, IL (US)

(72) Inventors: Kenney KOAY, Simpang Ampat (MY); Rosnah ANTONG, Perai (MY); Nur Diyana MOHD ASRI, Bayan Lepas (MY); Poh Imm GOH, Pulau Pinang (MY)

(21) Appl. No.: 18/394,202

(22) Filed: Dec. 22, 2023

(51) Int. Cl. H04W 4/029; G06V 40/20

(52) U.S. Cl. CPC H04W 4/029; G06V 40/20

(57) ABSTRACT

One or more computing devices establish a geofence around a location of a communication device, that encompasses at least two cameras from different camera systems, and configure a first camera within the geofence to be accessible by a communication device in response to a predetermined user gesture detected in first images from the first camera, that is from a first camera system. The computing device(s), in response to detecting the gesture, provide the communication device with access to: first current and historical video from the first camera. The computing device(s) generate from the first current video, a feature identifier of a user of the communication device and, in response to detecting the feature identifier in second current video from a second camera within the geofence, provide the communication device with access to: second current and historical video from the second camera that is associated with a second camera system.

### BACKGROUND OF THE INVENTION

A communication device operated by the first responder may require authorization access to cameras from the different camera systems, for example to retrieve video from the cameras for analysis. However, providing such access to the cameras from the different camera systems may be challenging, and furthermore negotiating and providing access to all the different camera systems may waste bandwidth between the communication device and the different camera systems. Furthermore, providing any access to the cameras comes with additional security challenges.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a system for analyzing video from cameras for tracking and access authorization, in accordance with some examples.

FIG. 2 is a device diagram showing a device structure of a device for analyzing video from cameras for tracking and access authorization, in accordance with some examples.

FIG. 3 is a flowchart of a method for analyzing video from cameras for tracking and access authorization, in accordance with some examples.

FIG. 4 depicts the system of FIG. 1 implementing a method for analyzing video from cameras for tracking and access authorization, in accordance with some examples.

FIG. 5 depicts the system of FIG. 1 continuing to implement a method for analyzing video from cameras for tracking and access authorization, in accordance with some examples.

FIG. 6 depicts the system of FIG. 1 continuing to implement a method for analyzing video from cameras for tracking and access authorization, in accordance with some examples.

FIG. 7 depicts the system of FIG. 1 continuing to implement a method for analyzing video from cameras for tracking and access authorization, in accordance with some examples.

FIG. 8 depicts the system of FIG. 1 continuing to implement a method for analyzing video from cameras for tracking and access authorization, in accordance with some examples.

FIG. 9 depicts the system of FIG. 1 continuing to implement a method for analyzing video from cameras for tracking and access authorization, in accordance with some examples.

FIG. 10 depicts the system of FIG. 1 continuing to implement a method for analyzing video from cameras for tracking and access authorization, in accordance with some examples.

FIG. 11 depicts the system of FIG. 1 continuing to implement a method for analyzing video from cameras for tracking and access authorization, in accordance with some examples.

FIG. 12 depicts the system of FIG. 1 continuing to implement a method for analyzing video from cameras for tracking and access authorization, in accordance with some examples.

FIG. 13 depicts the system of FIG. 1 continuing to implement a method for analyzing video from cameras for tracking and access authorization, in accordance with some examples.

FIG. 14 depicts the system of FIG. 1 continuing to implement a method for analyzing video from cameras for tracking and access authorization, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

When a first responder, such as a police officer, is deployed to a premises having a plurality of camera systems, the first responder generally needs quick access to video from the cameras nearest an incident, for example to investigate a suspect. In simple examples, a building manager give the first responder access to video from all the cameras, for example via a communication device of the first responder, but such access may waste bandwidth between the communication device and the cameras. Furthermore, the first responder may need access while moving around the premises to investigate the suspect (e.g., without having to find a building manager). Thus, there exists a need for an improved technical method, device, and system for analyzing video from cameras for tracking and access authorization.

An aspect of the present specification provides a method comprising: receiving, at one or more computing devices, an indication that a quick access camera mode (QAC) has been enabled at a communication device, the one or more computing devices communicatively coupled with a plurality of cameras from different camera systems; determining, at the one or more computing devices, a location of the communication device; establishing, via the one or more computing devices, a geofence around the location of the communication device, the geofence encompassing two or more cameras of the plurality of cameras; configuring, via the one or more computing devices, a first camera within the geofence to be accessible by the communication device in response to a predetermined user gesture detected in first images from the first camera, the first camera associated with a first camera system; in response to detecting the predetermined user gesture, providing, via the one or more computing devices, the communication device with access to: first current video from the first camera; and first historical video from the first camera stored at one more video databases; generating, via the one or more computing device, from the first current video from the first camera, a feature identifier of a user of the communication device; in response to detecting the feature identifier in second current video from a second camera, of the plurality of cameras, within the geofence, providing, via the one or more computing devices, the communication device with access to: the second current video from the second camera; and second historical video from the second camera stored at the one more video databases, the second camera associated with a second camera system.

Another aspect of the present specification provides a computing device comprising: a communication interface; a controller communicatively coupled with a plurality of cameras from different camera systems; and a computer-readable storage medium having stored thereon program instructions that, when executed by the controller, cause the controller to perform a set of operations comprising: receiving an indication that a quick access camera mode (QAC) has been enabled at a communication device; determining a location of the communication device; establishing a geofence around the location of the communication device, the geofence encompassing two or more cameras of the plurality of cameras; configuring a first camera within the geofence to be accessible by the communication device in response to a predetermined user gesture detected in first images from the first camera, the first camera associated with a first camera system; in response to detecting the predetermined user gesture, providing, via the communication interface, the communication device with access to: first current video from the first camera; and first historical video from the first camera stored at one more video databases; generating, via the one or more computing device, from the first current video from the first camera, a feature identifier of a user of the communication device; in response to detecting the feature identifier in second current video from a second camera, of the plurality of cameras, within the geofence, providing the communication device with access to: the second current video from the second camera; and second historical video from the second camera stored at the one more video databases, the second camera associated with a second camera system.

Each of the above-mentioned embodiments will be discussed in more detail below, starting with example system and device architectures of the system in which the embodiments may be practiced, followed by an illustration of processing blocks in for achieving an improved technical method, device, and system for microphonic noise compensation.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions and/or program code and/or computer program code. These computer program instructions and/or program code may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions and/or program code may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions and/or program code may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Herein, reference will be made to engines, which may be understood to refer to hardware, and/or a combination of hardware and software (e.g., a combination of hardware and software includes software hosted at hardware such that the software, when executed by the hardware, transforms the hardware into a special purpose hardware, such as a software module that is stored at a processor-readable memory implemented or interpreted by a processor), or hardware and software hosted at hardware and/or implemented as a system-on-chip architecture and the like.

Further advantages and features consistent with this disclosure will be set forth in the following detailed description, with reference to the drawings.

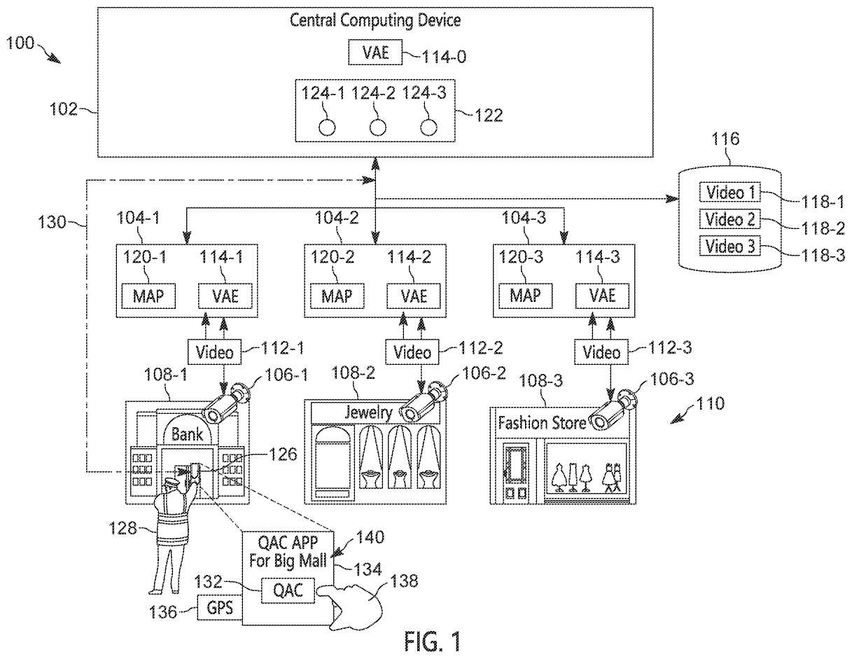

Attention is directed to FIG. 1, which depicts an example system 100 for analyzing video from cameras for tracking and access authorization. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like, unless otherwise indicated. In particular, wireless communication links are depicted using broken lines.

The system 100 comprises a central computing device 102, communicatively coupled with a plurality of computing devices 104-1, 104-2, 104-3, interchangeably referred to hereafter, collectively, as the computing devices 104 and, generically, as a computing device 104. This convention will be used throughout the present specification.

The computing devices 102, 104 may comprise one or more respective servers and/or one or more respective cloud servers, and the like. Alternatively, or in addition, the central computing device 102 may host a respective computing device 104, for example as a respective virtual machine, and the like (e.g., in a SaaS, PaaS, or IaaS environment and/or architecture, and the like).

As depicted, the computing devices 104 are communicatively coupled with at least one respective camera 106-1, 106-2, 106-3 interchangeably referred to hereafter, collectively, as the cameras 106 and, generically, as a camera 106. In some examples, the cameras 106 may comprise closed circuit television (e.g., CCTV) cameras, however the cameras 106 may comprise any suitable types of cameras.

While only one camera 106 is depicted as being communicatively coupled with a respective computing device 104, a respective computing device 104 may be communicatively coupled with a plurality of respective cameras 106.

For example, as depicted, it is understood that each combination of a computing device 104 and at least one camera 106 is associated with a respective region 108-1, 108-2, 108-3 (e.g., regions 108 and/or a region 108) of a larger premises 110 (e.g., that includes the regions 108). For example, as depicted, each region 108 corresponds to a store in the premises 110, and the premises 110 may comprise a mall, an airport, and the like. The regions 108 may alternatively be referred to as portion of the premises 110. While not depicted in FIG. 1, a plurality of respective cameras 106 may be deployed in each region 108, such as inside and/or outside a respective store of a region 108, and each of a plurality of respective cameras 106 associated with a region 108 is understood to be communicatively coupled with a respective computing device 104.

Furthermore, while the cameras 106 are depicted as being at an exterior of a store of a respective region 108, with an exterior area in front of a respective region 108 within a field-of-view (FOV) of such one or more cameras 106, one or more of the cameras 106 may be located at an interior of a respective region 108, with a FOV of such one or more cameras 106 being through a window, and the like, of a store of a respective region 108, such that the exterior area in front of a respective region 108 is within a FOV of such one or more cameras 106.

Indeed, each combination of a computing device 104 and at least one respective camera 106 is understood to form a respective camera system. For example, the combination of a first computing device 104-1 and at least one respective first camera 106-1 forms a first camera system, the combination of a second computing device 104-2 and at least one respective second camera 106-2 forms a second camera system, and the combination of a third computing device 104-3 and at least one respective third camera 106-3 forms a third camera system.

While three computing devices 104, three cameras 106 (e.g., three camera systems) and three regions 108 and are depicted, the system 100 may comprise any suitable number of computing devices 104, cameras 106 and regions 108, including as few as two computing devices 104, cameras 106, cameras systems, and regions 108, and more than three computing devices 104, cameras 106, cameras systems, and regions 108.

As depicted, the cameras 106-1, 106-2, 106-3 are acquiring respective video 112-1, 112-2, 112-3 (e.g., videos 112 and/or a video 112) and providing respective video 112 to a respective computing device 104. It is understood that any video provided herein comprises a plurality of images and optionally respective sound data.

As depicted, the central computing device 102, and the computing devices 104 comprise respective video analysis engines 114-0, 114-1, 114-2, 114-3 (e.g., video analysis engines (VAEs) 114 and/or a video analysis engine (VAE) 114). The VAEs 114 comprise respective engines that analyzes respective video 112 captured by respective cameras 106 using, for example, any suitable process that may include, but is not limited to machine learning algorithms, convolutional neural networks (CNNs), and the like. Using a VAE 114, a camera system (e.g., a respective computing device 104) may be configured to analyze video 112 to detect any activity and/or objects in the video. These analysis may include, but are not limited to, appearance searches, gesture searches, object searches, and the like, amongst other possibilities.

While the VAEs 114 are depicted as being at respective computing devices 104, in other examples, one or more of the VAEs 114 may be implemented by a respective camera 106.

As depicted, the central computing device 102 also includes a VAE 114-0. As such, any of the computing devices 102, 104 may perform analysis on received video.

In some examples, a computing device 104 may analyze respective video 112 (as described hereafter) and/or a computing device 104 may store respective video 112 at a database 116 (e.g., such as a memory, and the like, configured as a database), as respective historical video 118-1, 118-2, 118-3 (e.g., historical videos 118 and/or an historical video 118).

For example, first historical video 118-1 may comprise previous first video 112-1 received at the first computing device 104-1 from the first camera 106-1, second historical video 118-2 may comprise previous second video 112-2 received at the second computing device 104-2 from the second camera 106-2, and third historical video 118-3 may comprise previous third video 112-3 received at the third computing device 104-3 from the third camera 106-3.

While the historical video 118 is depicted as being stored at one database 116, the historical video 118 may be stored any suitable number of databases, for example a respective video database 116 of a computing device 104. Furthermore, it is understood that a given computing device 104 controls access to respective video 118 (e.g., and not the central computing device 102, though the central computing device 102 may configure a computing device 104 to access to respective video 118, for example for certain communication devices under certain conditions, as provided herein).

As depicted, the computing devices 104-1, 104-2, 104-3 store respective electronic maps 120-1, 120-2, 120-3 (e.g., the electronic maps 120, and/or an electronic maps 120) of a respective region 108-1, 108-2, 108-3. The electronic maps 120 may indicate a floorplan of a respective region 108, that may include, but is not limited to, positions of any suitable combination of rooms, walls, furniture, and cameras (e.g., respective cameras 106) of a respective region 108. As has been described, a respective camera system may comprise more than one respective camera 106 and hence, an electronic map 120 may show positions of any respective cameras 106, whether at an interior or an exterior of a region 108.

As depicted, the central computing device 102 also comprises an electronic map 122 that show respective locations 124-1, 124-2, 124-3 (e.g., locations 124 and/or a location 124) of the plurality of cameras 106. For example, the electronic map 122 may comprise a map of the premises 110, and may indicate hallways, pathways, and the like of the premises 110, but which may explicitly exclude the electronic maps 120 of the individual regions 108, for example for security purposes, other than the respective locations 124 of the plurality of cameras 106 that include exterior areas in front of respective regions 108 that are within a FOV the plurality of cameras 106. For example, entities associated with the regions 108 may have provided permission to an entity operating the larger premises to include locations 124 of such cameras 106 on the electronic map 122.

As depicted, it is understood that a first location 124-1 indicates a location of the first camera 106-1 in the premises 110, a second location 124-2 indicates a location of the second camera 106-2 in the premises 110, and a third location 124-3 indicates a location of the third camera 106-3 in the premises 110.

As will be explained herein, the electronic map 122 may be used by the central computing device 102 to establish geofences in the system 100.

As depicted, the system further comprises a communication device 126 being operated by a user 128. While as depicted, the user 128 comprises a first responder, such as a police officer, the user 128 may be any suitable operator of the communication device 126, including, but not limited to, other types of first responders (e.g., a fire fighter, an emergency medical technician), a security guard (e.g., a private first responder), and the like. For example, the user 128 may have been dispatched to the premises 110 to respond to an incident. As such, access to video (e.g., current video 112 and/or historical video 118) acquired by cameras 106 in the premises 110, via the communication device 126 may be requested. As the cameras 106 are components of different cameras systems, access to such video may be challenging. For example, the communication device 126 may be used to request access to video 112, 118 from individual computer systems, but such negotiating may be time consuming, and waste of bandwidth and processing resources at both the communication device 126 and the computing devices 104. As the computing devices 104 are communicatively coupled with the central computing device 102, a central request for access may occur. However, if the communication device 126 were immediately given access to all video 112, 118 associated with all the camera systems, more bandwidth and processing resources at both the communication device 126 and the computing devices 104 may be wasted to search for certain video 112, 118.

As depicted, the communication device 126 is in wireless communication with the central computing device 102, for example via a wireless communication link 130, and a quick access camera (QAC) mode may be enabled at the communication device 126 via actuation of a QAC (e.g., electronic) button 132, provided at a display screen 134 of the communication device 126. As depicted, aspects of the communication device 126 are shown in dashed lines from the communication device 126, including the display screen 134 of the communication device 126 show details thereof, as well as a location determining device 136. Furthermore, as depicted, the user 128 may be placing the communication device 126 into the QAC mode via actuation of the QAC button 132. For example, a hand 138 of the user 128 is also depicted as enlarged adjacent the display screen 134 showing actuation of the QAC button 132 via a touch screen of the display screen 134.

In particular, the QAC button 132 may be provided at the display screen 134 when the user 128 operates the communication device 126 to launch a QAC application (e.g., as indicated by text “QAC Application For Big Mall”; for example the premises 110 may be the “Big Mall”), which causes a graphic user interface (GUI) 140 to be provided at the display screen 134, the GUI 140 programmed to display and/or render the QAC button 132 and cause an indication of the QAC mode being enabled at the communication device 126 to be transmitted to the central computing device 102 when the QAC button 132 is actuated. As used herein, the term render is understood to include generating an image by means of a computer program, and displaying such an image at a display screen, such as the display screen 134. Furthermore, such an image, for example the GUI 140 and/or an image rendered by the GUI 140, may include interactive components, such as the QAC button 132. Hence, the communication device 126 may be configured to render the GUI 140, and detect when interactive components thereof are actuated, and/or the GUI 140 may comprise programming instructions that, when the GUI 140 is processed by the communication device 126, cause the GUI 140 to implement programming instructions to display various components of the GUI 140, and detect when interactive components thereof are actuated. Hence, hereafter, when the GUI 140 is described as providing certain components, it is understood that that the communication device 126 and/or the GUI 140 are programmed to display and/or render such components at the display screen 134, and when such components are interactive and/or actuatable, (e.g., such as the QAC button 132), it is further understood that the communication device 126 and/or the GUI 140 are programmed to receive input via such interactive and/or actuatable components, and perform an associated action in response.

Furthermore, while present examples are described with respect to a QAC application being launched, and/or the GUI 140 being provided at the display screen 134, in response to the QAC button 132 being actuated, a QAC application may be launched, and/or the GUI 140 may be provided at the display screen 134 in any suitable manner. For example, any suitable input may be received at the mobile device 126 to cause a QAC application to be launched, and/or to cause the GUI 140 to be provided at the display screen 134, including, but not limited to, actuation of any suitable physical and/or electronic button at the mobile device 126, selection of a menu item from a menu system, and the like, amongst other possibilities.

The communication device 126 may comprise any suitable communication device that may be operated by the user 128 and that includes a display screen (e.g., the display screen 134), including, but not limited to, one or more of a radio, a mobile device, a cell phone-type device, a laptop, and the like. As also depicted, the communication device 126 may include the location determining device 136, such as a global positioning system (GPS) device (as depicted), and the like, configured to determine a location of the communication device 126.

In general, the communication device 126, and the like, may be registered with the central computing device 102, and/or the communication device 126 may be configured with log-in credentials of the central computing device 102. For example, a first responder entity that deployed the user 128 may have an agreement with an entity that operates the central computing device 102, that indicates that communication devices operated by first responders of the first responder entity may be provided with at least communication access to the central computing device 102, so that communication devices may operate in a QAC mode with the system 100. Hence, it is understood that the communication device 126 is generally configured to communicate with the central computing device 102, via previously negotiated access permissions and/or log-in credentials provided to the communication device 126, and the like.

However, such access to the central computing device 102 does not include access to the camera systems (e.g., the computing devices 104) except under certain conditions as described herein, for example when the QAC mode of the communication device 126 is entered.

Operation of the system 100 when the QAC mode is entered is next described.

In general, when the QAC button 132 is actuated, the communication device 126 may enter a QAC mode, and provide an indication of such to the central computing device 102 via the wireless communication link 130. The communication device 126 may also provide a location of the communication device 126 to the central computing device 102 as determined via the location determining device 136.

However, the central computing device 102 may determine a location of the communication device 126 in any suitable manner, including, but not limited to, receiving, from the communication device 126, images (e.g., one or more images) and/or video acquired via a camera (not depicted) of the communication device 126 and analyzing such images and/or video via the VAE 114-0 to determine the location of the communication device 126. In such examples, it is understood that the VAE 114-0 has been configured to analyze images and/or video and determine a location in the premises 110 that corresponds to such images and/or video.

The central computing device 102 may locate the communication device 126 using the determined location at the electronic map 122, and establish a geofence encompassing two or more of the plurality of cameras 106, which may include cameras 106 within a given distance of the user 128.

The central computing device 102 may, in a QAC mode, enable the VAEs 114 associated with cameras 106 within the geofence to enter a gesture analysis mode to analyze respective video 112 for a predetermined user gesture. Alternatively, or in addition, the VAE 114-0 of the central computing device 102 may receive such video 112 and perform such analysis.

For example, the user 128 may be in a FOV of one or more cameras 106 within the geofence and the user 128 may perform the predetermined user gesture that may be detected via video 112 acquired by one or more cameras 106 within the geofence.

In some examples, the user 128 may have foreknowledge of the predetermined user gesture. In other examples, GUI 140 may be programmed to display and/or render, at the display screen 134, text and/or image and/or video based instructions for performing the predetermined user gesture, for example as stored at the QAC application at the communication device 126. In yet further examples, the central computing device 102 may transmit, via the wireless communication link 130, to the communication device 126, text and/or image and/or video based instructions for performing the predetermined user gesture, and the GUI 140 may display and/or render, at the display screen 134, such text and/or image and/or video based instructions.

The predetermined user gesture may be a series of one or more physical actions that the user 128 performs, such as pointing to a camera 106, waving an arm in a particular manner (e.g., up then down, then left to right), and/or bending, or bowing a given number of times, and/or jumping up and down a given number of times, and/or any other suitable predetermined user gesture.

When the predetermined user gesture is detected in video 112 from a camera 106 within the geofence, the central computing device 102 configures the camera 106 to be accessible by the communication device 126.

For example, the camera 106 and/or a corresponding computing device 104 may be provided with authorization credentials of the communication device 126 such that, when the communication device 126 requests access to respective video 112 and/or respective historical video 118, the camera 106 and/or the corresponding computing device 104 authorizes access to such respective video 112 and/or respective historical video 118. For example, when the communication device 126 establishes communication with the central computing device 102 and/or when the communication device 126 provides the indication of the QAC mode to the central computing device 102, the communication device 126 may provide authorization credentials thereof to the central computing device 102, that may include, but is not limited to, an email address, a MAC (media access control) address, a telephone number, and/or any other suitable identifier that identifies, and/or uniquely identifies, the communication device 126 in the system 100. It is understood that when the communication device 126 later requests access to video 112 and/or historical video 118 from a camera 106 and/or a corresponding computing device 104, such a request includes the same credentials so that the camera 106 and/or the corresponding computing device 104 may determine that such a request is received from a communication device that has been authorized to access respective video 112 and/or historical video 118.

In particular, in response to the predetermined user gesture being detected, the communication device 126 is provided with access to: current video 112 from the camera 106 associated with the detection of the predetermined user gesture, and associated historical video 118. Such access may be via the associated computing device 104 for example and/or the central computing device 102, though access by the communication device 126 to the video 112, 118 is understood to be initiated via the configuring of the associated camera 106 and/or associated computing device 104 for such access.

Once access is authorized, an indication of such access may be provided to the communication device 126 (e.g., by the central computing device 102 and/or the computing device 104 associated with the access), and the GUI 140 may be updated such that the GUI 140 is programmed to provide current video 112 from the camera 106 associated with the detection of the predetermined user gesture, and associated historical video 118.

For example, the GUI 140 may be programmed to display and/or render an electronic button for requesting that current video 112 from the camera 106 be streamed to the communication device 126, and/or the GUI 140 may be programmed to display and/or render an interactive interface for requesting associated historical video 118 for a given time period (e.g., such as a date and time of the incident to which the user 128 was dispatched). When the electronic button for requesting that current video 112 is actuated, the current video 112 may be streamed to the communication device 126 from the camera 106 and be displayed and/or rendered at the GUI 140. When the interactive interface for requesting associated historical video 118 is operated to request historical video 118 for a given time period, the historical video 118 may be streamed and/or transmitted to the communication device 126 by the respective computing device 104, from the database 116, and be displayed and/or rendered at the GUI 140. The GUI 140 may furthermore be programmed to display and/or render any suitable controls for controlling and/or playing video 112, 118, including, but not limited to, a pause control, a resume control, a forward and/or fast forward control, a reverse and/or fast reverse control, and the like, amongst other possibilities.

Furthermore, one or more of the central computing device 102 and/or the computing device 104 at which access is authorized may generate, from current video 112 from the respective camera 106, a feature identifier of the user 128 of the communication device 126. For example, from the current video 112, a machine learning classifier corresponding to a face of the user 128 may be generated, that may be used by machine learning algorithms of the VAEs 114 to detect the user 128 in video 112. However, such a feature identifier may comprise any suitable feature identifier for detecting the user 128 in video 112. Furthermore, such a feature identifier may be for detecting any suitable feature of the user 128, that may include, but is not limited to, a face of the user 128, a gait of the user 128, and the like. Indeed, such a feature identifier may independent of certain clothing of the user 128 as, for example, if the user 128 is wearing a jacket, the user 128 may remove the jacket and hence the feature identifier would generally not be generated for such a jacket.

Alternatively, or in addition, as an appearance of the user 128 changes (e.g., the user 128 removes a jacket), as indicated by video 112 that includes the user 128, a feature identifier of the user 128 may be updated accordingly.

The feature identifier may be provided to the VAEs 114 associated with the cameras 106 within the geofence so that the user 128 may be detected in respective video 112.

In response to detecting the feature identifier in current video 112 from another camera 106 within the geofence, the communication device 126 may be provided with access (e.g., similar to as described above) to: the current video 112 from the other camera 106 as well as associated historical video 118. The GUI 140 may be updated accordingly, so that the current video 112 from the other camera 106 as well as associated historical video 118 may be requested and provided via the GUI 140.

Hence, as the user 128 walks around the premises 110, and is detected via cameras 106 within the geofence, the communication device 126 is authorized to access to respective video 112, 118 associated with such cameras 106.

Furthermore, as a location of the user 128 changes (e.g., due the user 128 walking around the premises 110), a path of the user 128 may be determined and/or predicted by the central computing device 102 and the geofence may be extended to encompass further cameras 106 that are predicted to be along the path of the user 128. Associated VAEs 114 of such cameras 106 may be provided with the feature identifier so that the user 128 may be identified in video 112 from such cameras 106, to authorize access to the communication device 126 to the associated video 112, 118.

In some examples, an electronic map showing visual indications of respective locations 124 of the one or more cameras 106 within the geofence may be provided to the communication device 126 by the central computing device 102. For example, such an electronic map may comprise a portion of the electronic map 122 (e.g., excluding respective locations 124 of cameras 106 outside the geofence).

Such an electronic map provided to the communication device 126 may include the respective electronic maps 120 of the regions 108 associated with the cameras 106 within the geofence. Indeed, the electronic map provided to the communication device 126 may be interactive and provided at the display screen 134 via the GUI 140. For example, visual indications of the locations 124 of the cameras 106 may be actuatable such that, to access respective video 112, 118 of the cameras 106, a respective visual indication may be actuated.

Furthermore, when the respective electronic maps 120 of the regions 108 include respective visual indications of respective other cameras 106 associated with the regions 108, respective current video and respective historical video from such cameras 106 may also be accessed via actuating of the respective visual indications.

Furthermore, as the geofence is extended to include additional cameras 106, the electronic map provided to the communication device 126 may be updated by the central computing device 102 to include respective visual indications of locations of such additional cameras 106, as well as respective electronic maps 122 of associated regions 108.

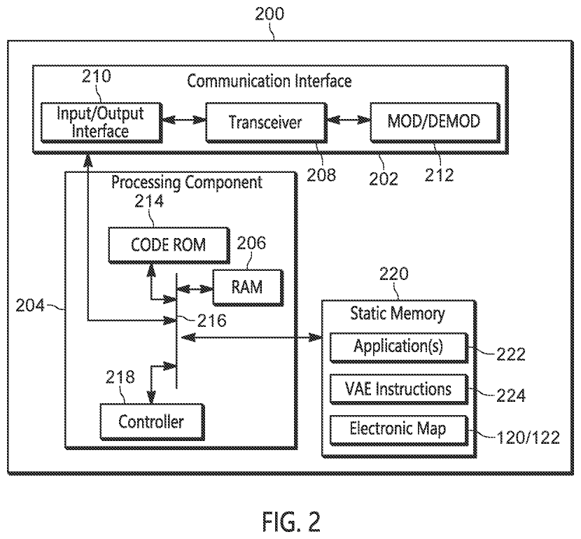

Attention is next directed to FIG. 2, which depicts a schematic block diagram of an example of a computing device 200, that may be an example of one or more of the computing devices 102, 104.

As depicted, the computing device 200 comprises: a communication interface 202, a processing component 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the computing device 200 may have any suitable structure and/or configuration.

While not depicted, the computing device 200 may include one or more of an input device and a display screen and the like.

As shown in FIG. 2, the computing device 200 includes the communication interface 202 communicatively coupled to the common data and address bus 216 of the processing component 204.

The processing component 204 may include the code Read Only Memory (ROM) 214 coupled to the common data and address bus 216 for storing data for initializing system components. The processing component 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other suitable components of the system 100.

For example, the communication interface 202 may include one or more transceivers 208 and/or wireless transceivers for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network.

Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

However, at least a digital mobile radio (DMR) network, a Project 25 (P25) network, a terrestrial trunked radio (TETRA) network and any corresponding DMR transceiver, P25 transceiver, and TETRA transceiver may be dedicated for communication with the communication device 126, for example via the wireless communication link 130, for example when the communication device 126 comprises a first responder communication device.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the computing device 200 is not a generic controller and/or a generic device, but a device specifically configured to implement functionality for analyzing video from cameras for tracking and access authorization. For example, in some examples, the computing device 200 and/or the controller 218 specifically comprises a computer executable engine configured to implement functionality for analyzing video from cameras for tracking and access authorization.

The static memory 220 comprises a non-transitory machine readable medium that stores machine readable instructions to implement one or more programs or applications and/or program code. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the computing device 200 as described herein are maintained, persistently, at the memory 220 and used by the controller 218, which makes appropriate utilization of volatile storage during the execution of such programming instructions.

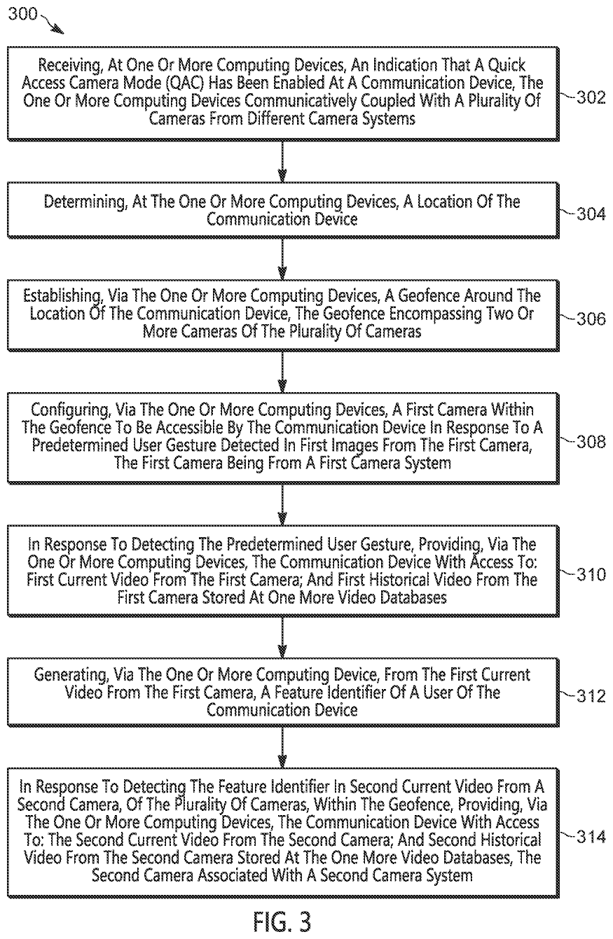

In particular, the memory 220 stores instructions and/or program code corresponding to the at least one application 222 that, when executed by the controller 218, enables the controller 218 to implement functionality for analyzing video from cameras for tracking and access authorization, including but not limited to, the blocks of the methods set forth in FIG. 3.

Indeed, the memory 220 may comprise a computer-readable storage medium having stored thereon program instructions that, when executed by the controller 218, cause the controller 218 to perform a set of operations to implement functionality for emergency personal data access using different communication interface types, including but not limited to, the blocks of the methods set forth in FIG. 3

As depicted, the memory 220 further stores VAE instructions 224, for implementing a VAE 114, and the VAE instructions 224 may be stored separately from the application 222 (e.g., as depicted), or the VAE instructions 224 may be a component of the application 222.

As depicted, the memory 220 further stores one or more electronic maps 120, 122 (e.g., depending on whether the computing device 200 is configured as the central computing device 102 and/or one or more of the computing devices 104).

The memory 220 may alternatively comprise at least a portion of the database 116 and hence the memory 220 may store at least a portion of the historical video 118.

The application 222 and/or the VAE instructions 224 may include programmatic algorithms, and the like, to implement functionality as described herein.

Alternatively, and/or in addition to programmatic algorithms, the application 222 and/or the VAE instructions 224 may include one or more machine learning algorithms to implement functionality as described herein.

The one or more machine learning algorithms of the application 222 and/or the VAE instructions 224 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

While components of the communication device 126 are not depicted, the communication device 126 may have a structure similar to that of the computing device 200, but adapted for respective functionality of the communication device 126. For example, the communication device 126 is understood to comprise the display screen 134 and one or more input devices (e.g., including, but not limited to, a touch screen of the display screen 134), the location determining device 136, and the like, in addition to the components depicted in FIG. 2.

Attention is now directed to FIG. 3, which depicts a flowchart representative of a method 300 for analyzing video from cameras for tracking and access authorization. The operations of the method 300 of FIG. 3 correspond to machine readable instructions that are executed by the one or more of the computing devices 102, 104, such as the controller 218 the one or more of the computing devices 102, 104. In the illustrated example, the instructions represented by the blocks of FIG. 3 are stored at the memory 220 for example, as the application 222 and/or the VAE instructions 224. The method 300 of FIG. 3 is one way in which the controller 218 and/or the computing devices 102, 104 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

It is furthermore understood in the following discussion that the one or more computing devices 102, 104 are communicatively coupled to a plurality of cameras 106 from different camera systems.

Furthermore, as functionality of the computing devices 102, 104 may be distributed therebetween, the method 300 may be performed via one or more of the computing devices 102, 104. However, in a particular example, the method 300 is performed by the central computing device 102.

At a block 302, the controller 218, and/or one or more of the computing devices 102, 104, receives an indication that a quick access camera mode (QAC) has been enabled at the communication device 126.

At a block 304, the controller 218, and/or one or more of the computing devices 102, 104, determines a location of the communication device 126.

At a block 306, the controller 218, and/or one or more of the computing devices 102, 104, establishes a geofence around the location of the communication device 126, the geofence encompassing two or more cameras 106 of the plurality of cameras 106.

At a block 308, the controller 218, and/or one or more of the computing devices 102, 104, configures a first camera 106 (e.g., the first camera 106-1) within the geofence to be accessible by the communication device 126 in response to a predetermined user gesture detected in first images (e.g., and/or in first video) from the first camera 106, the first camera 106 associated with first camera system.

Providing such access of the communication device 126 to the first camera 106, may include the central computing device 102 providing the aforementioned authorization credentials to the first camera 106 and/or to the associated computing device 104.

In some examples, detecting the predetermined user gesture in the first images from the first camera 106 may include a VAE 114 of a computing device 104 associated with the first camera 106 detecting the predetermined user gesture. However, when the method 300 is performed by the central computing device 102, detecting the predetermined user gesture in the first images from the first camera 106 may include the central computing device 102 receiving an indication from the computing device 104 associated with the first camera 106 that the predetermined user gesture was detected.

Hence, put another way, the block 308 may comprise the controller 218, and/or one or more of the computing devices 102, 104, configuring a first camera 106 (e.g., the first camera 106-1) within the geofence to be accessible by the communication device 126 in response to a determination that a predetermined user gesture was detected in first images (e.g., and/or in first video) from the first camera 106.

At a block 310, the controller 218, and/or one or more of the computing devices 102, 104, in response to detecting the predetermined user gesture, provides the communication device 126 with access to: first current video 112 from the first camera 106; and first historical video 118 from the first camera 106 stored at one more video databases 116.

Put another way, the block 310 may comprise, the controller 218, and/or one or more of the computing devices 102, 104, in response to determining that the predetermined user gesture was detected, providing the communication device 126 with access to: first current video 112 from the first camera 106; and first historical video 118 from the first camera 106 stored at one more video databases 116.

At a block 312, the controller 218, and/or one or more of the computing devices 102, 104, generates, from the first current video 112 from the first camera 106, a feature identifier of a user 128 of the communication device 126.

At a block 314, the controller 218, and/or one or more of the computing devices 102, 104, in response to detecting the feature identifier in second current video 112 from a second camera 106 (e.g., the second camera 106-2), of the plurality of cameras 106, within the geofence, provides the communication device 126 with access to: the second current video 112 from the second camera 106; and second historical video 118 from the second camera 106 stored at the one more video databases 116, the second camera 106 associated with a second camera system.

Providing such access of the communication device 126 to the second camera 106, may include the central computing device 102 providing the aforementioned authorization credentials to the second camera 106 and/or to the associated computing device 104.

In some examples, detecting the feature identifier in second current video 112 from a second camera 106 may include a VAE 114 of a computing device 104 associated with the second camera 106 detecting the feature identifier. Hence, when the method 300 is performed by the central computing device 102, detecting the feature identifier in second current video 112 from a second camera 106 may include the central computing device 102 receiving an indication from the computing device 104 associated with the second camera 106 that the feature identifier was detected.

The method 300 may include further features.

For example, the method 300 may further comprise, the controller 218, and/or one or more of the computing devices 102, 104: in response to detecting the predetermined user gesture in both the first images from the first camera 106 and second images from the second camera 106, providing, to the communication device 126, video from, or respective indications of, both the first camera 106 and the second camera 106, to enable selection of the first camera 106 or the second camera 106 as an initial camera 106 to which the communication device 126 is provided access to respective current video 112 and respective historical video 118.

The method 300 may further comprise, the controller 218, and/or one or more of the computing devices 102, 104: in response to detecting the predetermined user gesture in the first images from the first camera 106, automatically authorizing, via the one or more computing devices 102, 104, access by the communication device 126 to respective video associated with all of the plurality of cameras 106 located within the geofence.

Providing such access of the communication device 126 to all of the plurality of cameras 106 located within the geofence, may include the central computing device 102 providing the aforementioned authorization credentials to all of the plurality of cameras 106 located within the geofence and/or the associated computing devices 104.

For example, configuring the first camera 106 (and/or all the cameras 106) within the geofence to be accessible by the communication device 126 (e.g., at the block 308) in response to the predetermined user gesture detected in the images from the first camera 106 may occur further in response to: receiving (e.g., at the one or more computing devices 102, 104), from the communication device 126, authorization credentials.

In particular, configuring the first camera 106 within the geofence to be accessible by the communication device 126 (e.g., at the block 308) may occur further in response to: receiving, at the central computing device 102, from the communication device 126, authorization credentials; and providing the authorization credentials, from the central computing device 102 to the first camera 106 at which video 112 was acquired in which the predetermined gesture was detected, and/or an associated computing device 104.

The method 300 may further comprise, the controller 218, and/or one or more of the computing devices 102, 104: determining a path of the user 128 relative to the geofence using locations of the communication device 126, the locations one or more of: received from the communication device 126, and determined from respective video 112 from the first camera 106 and the second camera 106; and extending the geofence, based on the path, to encompass one or more further cameras 106 of the plurality of cameras 106.

For example, locations of the user 128 as function of time may be determined from the respective video 112 from the first camera 106 and the second camera 106, and used (e.g., by one or more of the computing devices 102, 104) to predict a path of the user 128.

In particular, the method 300 may further comprise, the controller 218, and/or one or more of the computing devices 102, 104: determining a path of the user 128 relative to the geofence; extending the geofence, based on the path, to encompass one or more further cameras 106 of the plurality of cameras 106; and searching for the feature identifier in respective current video 112 from the one or more further cameras 106, of the plurality of cameras 106, to further provide the communication device 126 with access to: the respective current video 112 from the one or more further cameras 106 of the plurality of cameras 106; and respective historical video 118 from the one or more further cameras 106, of the plurality of cameras 106, stored at one more video databases 116.

Providing such access of the communication device 126 to the further cameras 106 may include the central computing device 102 providing the aforementioned authorization credentials to the further cameras 106 and/or to associated computing devices 104.

Put another way, the method 300 may further comprise, the controller 218, and/or one or more of the computing devices 102, 104: determining a path of the user 128 relative to the geofence; extending the geofence, based on the path, to encompass at least a third camera 106 of the plurality of cameras 106; and in response to detecting the feature identifier in third current video 112 from the third camera 106, providing the communication device 126 with access to: the third current video 112 from the third camera 106; and third historical video 118 from the third camera 106 stored at the one more video databases 116.

Providing such access of the communication device 126 to the third camera 106, may include the central computing device 102 providing the aforementioned authorization credentials to the third camera 106 and/or to the associated computing device 104.

Put yet another way, the method 300 may further comprise, the controller 218, and/or one or more of the computing devices 102, 104: determining a path of the user 128 relative to the geofence; extending the geofence; and automatically authorizing, via the one or more computing devices 102, 104, access by the communication device 126 to respective video 112 associated with all of the plurality of cameras 106 located within the geofence as extended.

Providing such access of the communication device 126 to the all of the plurality of cameras 106 located within the geofence as extended may include the central computing device 102 providing the aforementioned authorization credentials to the all of the plurality of cameras 106 located within the geofence as extended and/or to associated computing devices 104.

The method 300 may further comprise, the controller 218, and/or one or more of the computing devices 102, 104: providing, to the communication device 126, an electronic map showing: respective locations 124 of the one or more cameras 106 of the two or more cameras 106 (e.g., of the block 306); and a floorplan of at least a portion of a premises (e.g., a region 108) associated with the two or more cameras 106, wherein the respective locations of the two or more cameras 106 are provided as selectable icons that, when selected at the communication device 126, cause an indication of selection to be received at the one or more computing devices 102 104, which responsively provides access to respective historical video 118 of an associated camera 106.

Providing such access of the communication device 126 to a selected associated camera 106 may include the central computing device 102 providing the aforementioned authorization credentials to the all of the selected associated camera 106 and/or to an associated computing device 104.

Furthermore, in some examples, the central computing device 102 may generate the electronic map provided to the communication device 126 by processing the electronic map 120 to remove indications of locations 124 of the cameras 106 outside the geofence, requesting electronic maps 120 from computing devices 104 associated with cameras 106 inside the geofence, and combining such electronic maps 122 with the electronic map to be provided to the communication device 126.

The central computing device 102 may further process the electronic map to be provided to the communication device 126 to embed respective links and/or programming code at locations 124 of any cameras 106 indicated in the electronic map (including at camera locations not represented in the electronic map 122, but represented in the electronic maps 120 from the computing devices 104) that are selectable to provides access to respective historical video 118 of an associated camera 106. For example, such respective links and/or programming code may include a network address, and the like, of a camera 106 from which current video may be streamed upon selection thereof, and/or such respective links and/or programming code may include a respective network address, and the like, of a historical video at the one or more video databases 116 that may be streamed and/or provided to the communication device 126 upon selection thereof.

It is further understood that the electronic map provided to the communication device 126 may be provided at the GUI 140 at the display screen 138.

In some examples, the method 300 may further comprise, the controller 218, and/or one or more of the computing devices 102, 104: providing, to the communication device 126, an electronic map showing: respective locations of the two or more cameras 106 (e.g., of the block 306) of the plurality of cameras 106; and a floorplan of at least a portion of a premises (e.g., a region 108) associated with the two or more cameras 106; and, in response to the geofence being extended to include one or more further cameras 106, of the plurality of cameras 106, providing, to the communication device 126, an updated electronic map showing: the respective locations of the two or more cameras 106 and the one or more further cameras 106, of the plurality of cameras 106; and an updated floorplan of at least an updated portion of the premises associated with the two or more cameras 106 and the one or more further cameras 106. The updated electronic map may be generated by stitching the electronic maps 120 associated with the more further cameras 106 to the previously provided electronic map.

Hence, when the geofence is extended to include further cameras 106, the electronic maps 120 of computing devices 104 associated with the further cameras 106 may be requested by the central computing device 102 and added to the electronic map provided to the communication device 126. The updated electronic map is understood to include respect links and/or programming code for requesting and/or streaming associated current video and/or historical video. In some examples, a new updated electronic map may be provided to the communication device 126 that replaces the previously provided electronic map.

However, in some examples, to reduce bandwidth usage between the communication device 126 and the one or more computing devices 102, 104, only the electronic maps 120 of computing devices 104 associated with the further cameras 106 may be provided to the communication device 126, which adds the electronic maps 120 to the previously received electronic map (e.g., stitching the new electronic maps 120 to the previously received electronic map). It is understood, however, that the electronic maps 120 provided to the communication device 126 include the aforementioned links and/or programming code for requesting and/or streaming associated current video and/or historical video.

In some examples, it is further understood that the aforementioned links and/or programming code for requesting and/or streaming associated current video and/or historical video may be embedded at the electronic maps 120, 122 when generated.

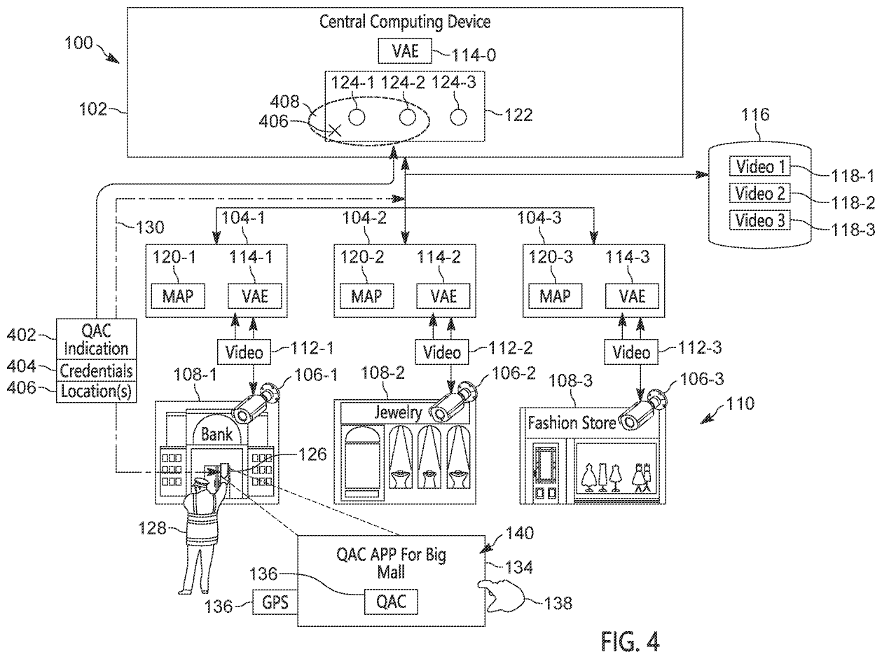

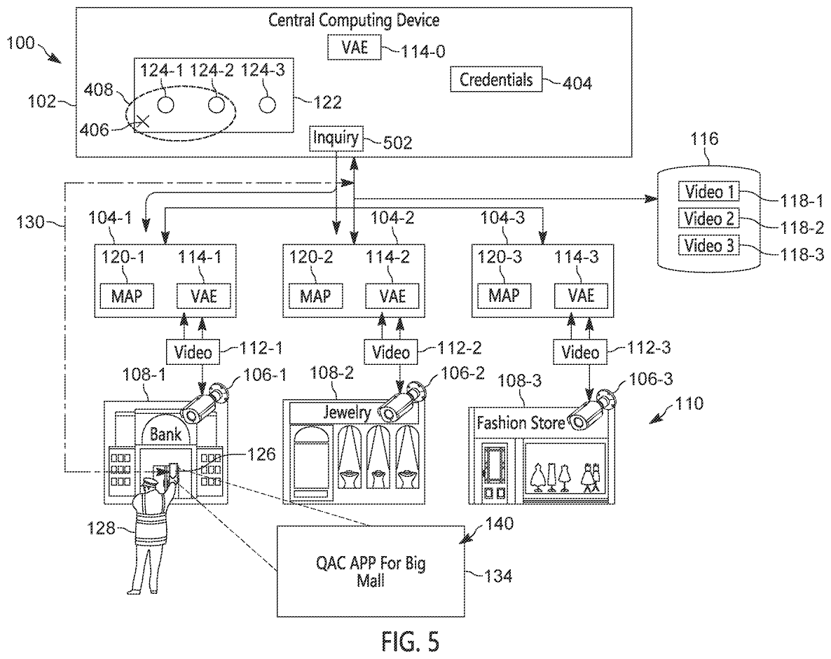

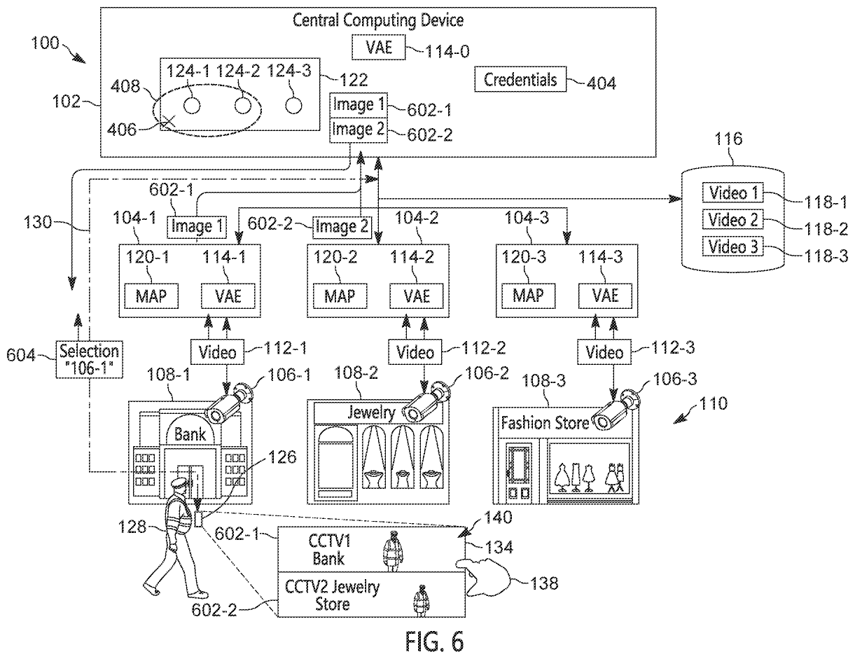

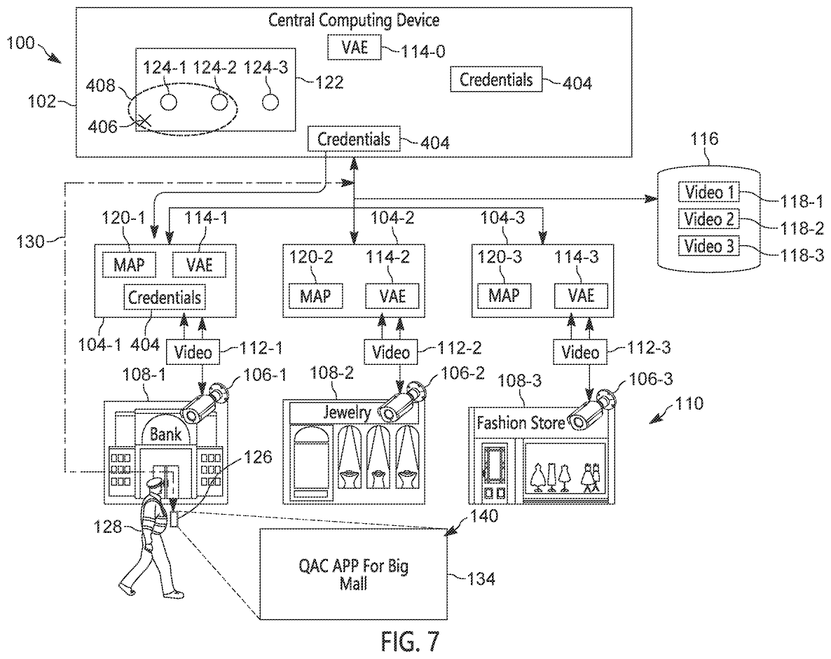

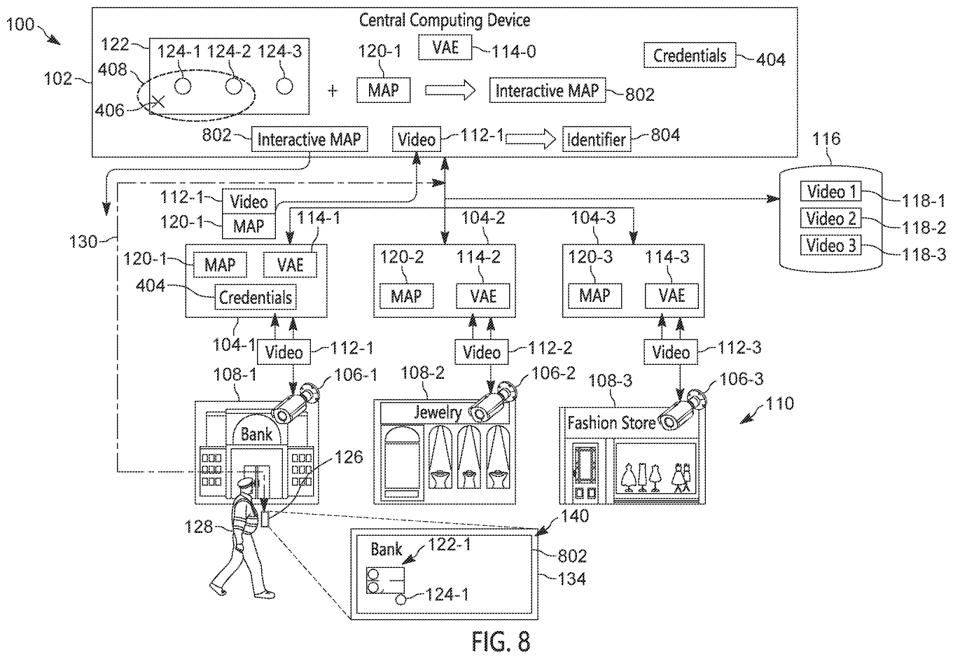

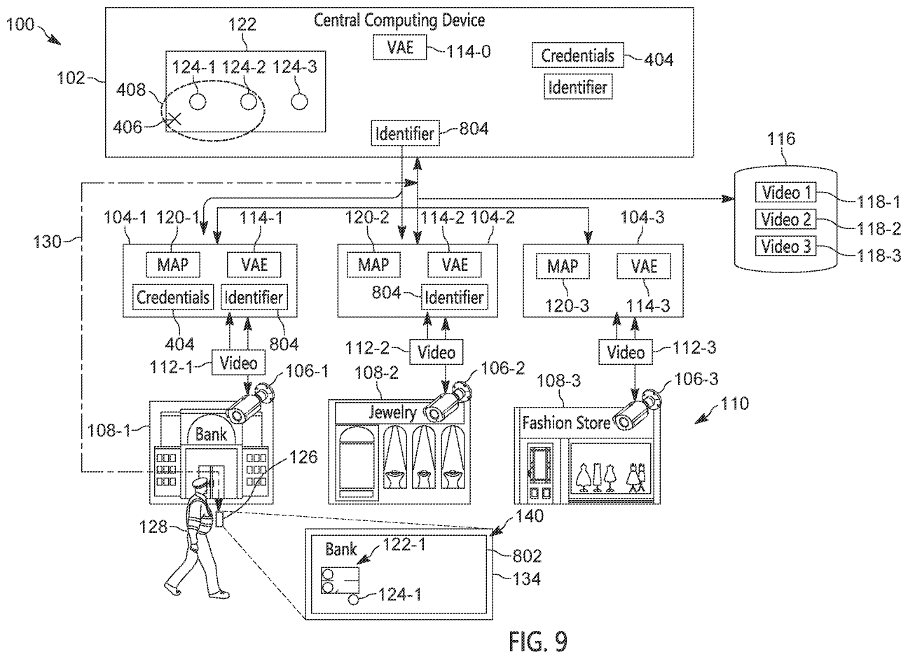

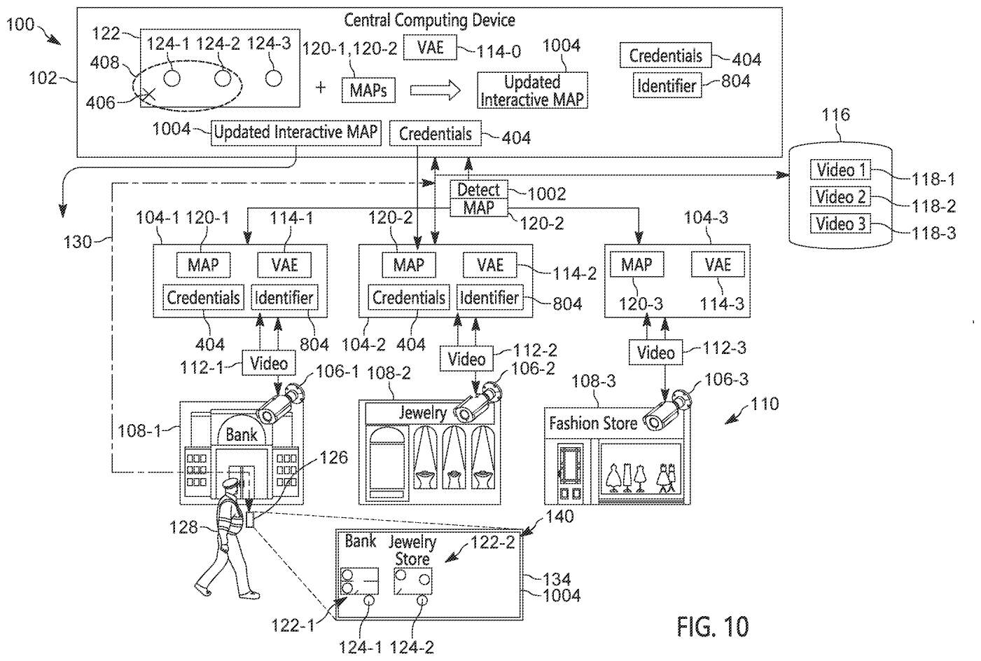

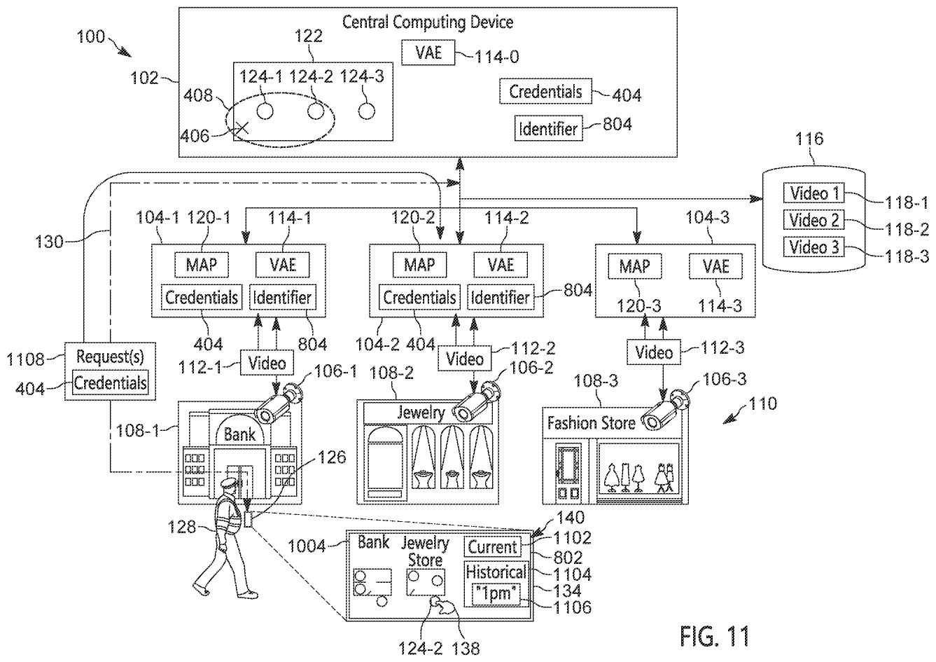

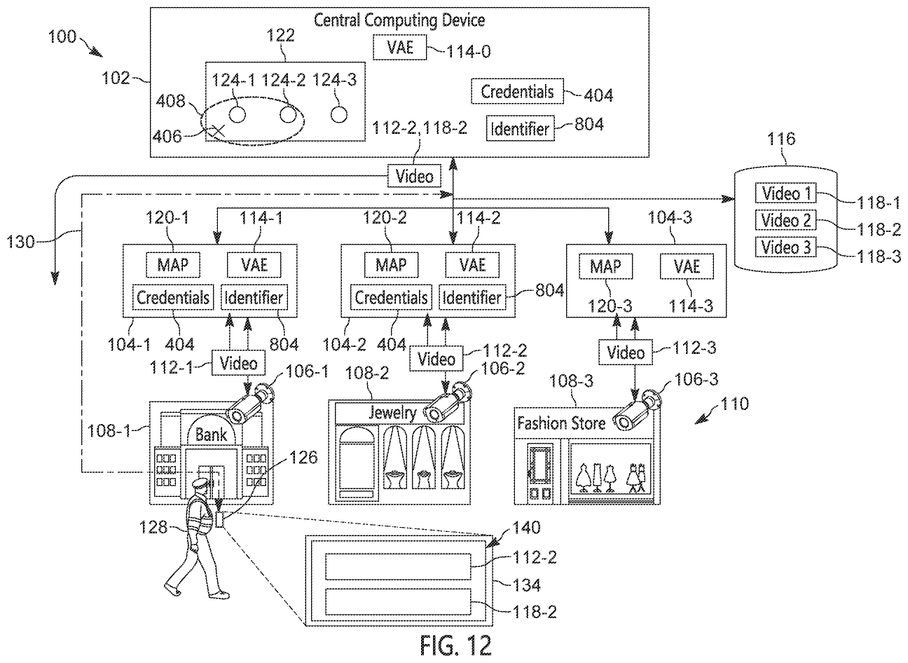

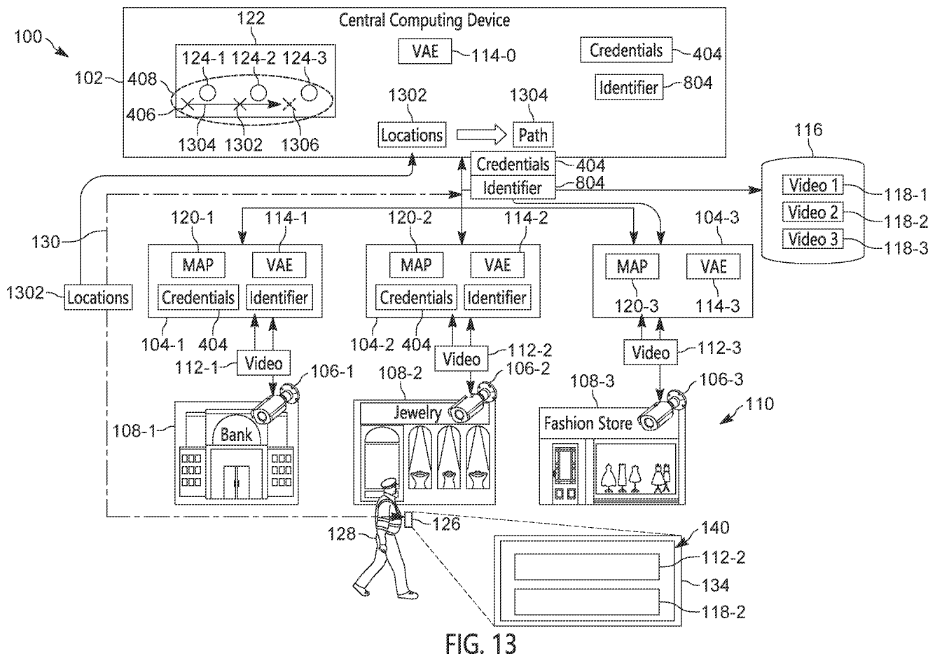

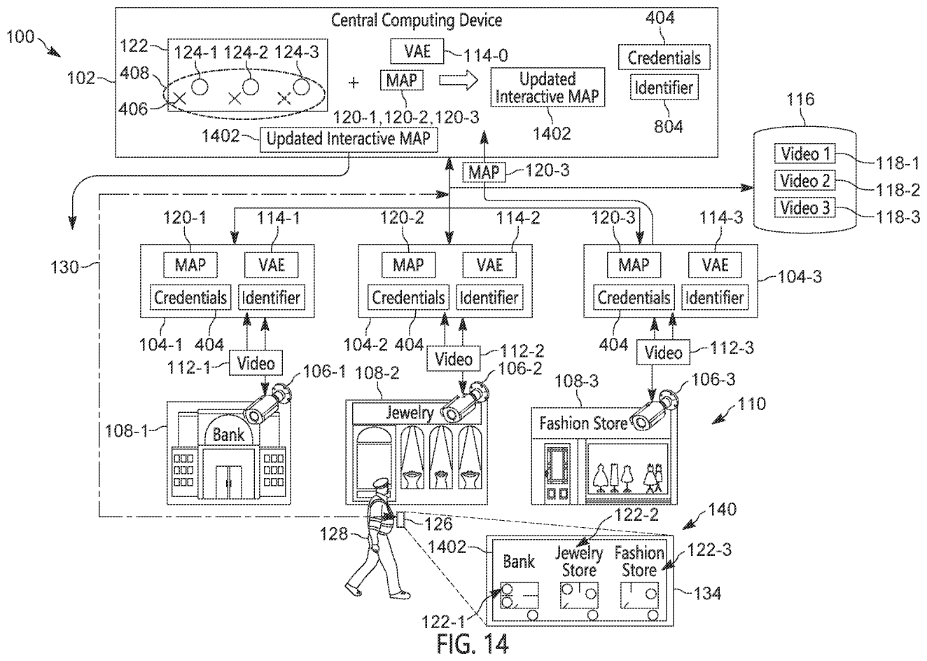

Aspects of the method 300 are next directed to FIG. 4, FIG. 5, FIG. 6, FIG. 7, FIG. 8, FIG. 9, FIG. 10, FIG. 11, FIG. 12, FIG. 13, and FIG. 14, which are substantially similar to FIG. 1 with like components having like numbers.

With attention first directed to FIG. 4, the user 128 actuates the QAC button 132, which causes the communication device 126 to transmit to the central computing device 102 (e.g., via the wireless communication link 130) an indication 402 of the QAC mode being enabled at the communication device 126, as well as the aforementioned authorization credentials 404 and the location 406 of the communication device 126. While not depicted, the communication device 126 may transmit locations 406 of the communication device 126 to the central computing device 102 periodically and/or as the communication device 126 moves.

Hereafter, communication between the communication device 126 and the other components of the system 100 are understood to occur via the wireless communication link 130.

The central computing device 102 receives (e.g., at the block 302 of the method 300) the indication 402, as well as the credentials 404 and the location 406. The central computing device 102 is understood to process the credentials 404 and to authorize access by the communication device 126 to the video 112, 118. For example, as previously discussed, in general, the communication device 126, and the like, may be registered with the central computing device 102, and/or the communication device 126 may be configured with log-in credentials of the central computing device 102. Hence, the credentials 404 may comprise log-in credentials and the central computing device 102 may confirm and/or verify that the credentials 404 match and/or correspond to predetermined log-in credentials.

The receipt of the indication 402 may trigger the central computing device 102 to determine (e.g., at the block 304 of the method 300) the location 406 of the communication device 126, for example by receiving the location 406 from the communication device 126 (e.g., as depicted) and/or the communication device 126 may provide images (not depicted), and the like, from a camera thereof to the central computing device 102, and the central computing device 102 may analyze such images using the VAE 114-0 to determine the location 406. In particular, when the location 406 of the communication device 126 is not received with the indication 402, the central computing device 102 may request the location 406 (and/or images) from the communication device 126.

Using the location 406 of the communication device 126, the central computing device 102 establishes (e.g., at the block 304 of the method 300) a geofence 408 around the location 406 of the communication device 126. For example, as depicted, the central computing device 102 may locate the location 406 at the electronic map 122 and establish the geofence 408 around the location 406 such that the geofence encompasses two or more cameras 106 of the plurality of cameras 106. For example, as depicted, the geofence 408 encompasses the locations 124-1, 124-2 of the cameras 106-1, 106-2, that are hence understood to be inside the geofence 408. The geofence 408 may be established according to any suitable process, such extending from the location 406 by a given distance (e.g., along a hallway in front of the locations 124), such 10 meters, 20 meters, 30 meters, amongst other possibilities. The geofence 408 may furthermore have any suitable shape (e.g., as depicted elliptical, or circular, or square or rectangular, and the like). Furthermore, when the geofence 408 does not encompass two or more cameras 106 from different cameras systems, the central computing device 102 may extend the geofence 408 to encompass two or more cameras 106 from different cameras systems.

It is furthermore understood that, after actuating the QAC button 132, the user 128 may perform the aforementioned predetermined user gesture in a FOV of one or more of the cameras 106. For example, the user 128 may point to the nearest camera 106 (e.g., such as the first camera 106-1), however more than one camera 106 within the geofence 408 may acquire respective video 112 that includes the predetermined user gesture.

Hereafter, for simplicity, the location determining device 136 is omitted from the figures, though the location determining device 136 is nonetheless understood to be present.

With attention next directed to FIG. 5, which is understood to follow from FIG. 4, the central computing device 102 provides an inquiry 502 to the computing devices 104-1, 104-2 associated with the cameras 106-1, 106-2 within the geofence 408. The inquiry 502 is understood to request that the respective VAEs 114-1, 114-2 search for the predetermined user gesture in respective video 112.

With attention next directed to FIG. 6, which is understood to follow from FIG. 5, it is understood that both the VAEs 114-1, 114-2 detected the predetermined user gesture in respective video 112, and the computing devices 104-1, 104-2 provide, to the central computing device 102 respective images 602-1, 602-2 (e.g., the images 602, and/or an image 602) (or alternatively a portion of the video 112-1, 112-2) that may include the user 128 (e.g., performing or not (as depicted) performing the predetermined user gesture). The images 602 are provided to the communication device 126, which renders the images 602 as actuatable buttons at the GUI 140 at the display screen 134 (e.g., and as depicted, respectively labelled as “CCTV1 BANK” and “CCTV2 JEWELY STORE” to identify the cameras 106-1, 106-2 from which the images 602 were received; the may provide such labels). The user 128 may select an image 602 associated with a camera 106 to which the user 128 wants access; for example, as depicted, the user 128 touched (using their hand 138) the image 602-1. The communication device 126 responsively provides a selection 604 of the first camera 106-1 (e.g., as indicated by text “106-1” in the selection 604) to the central computing device 102.

Hence, in response to detecting the predetermined user gesture in both the first image 602-1 from the first camera 106-1 and the second image 602-2 from the second camera 106-2, the central computing device 102 may provide to the communication device 126, one or more of video and/or images from, or respective indications of, both the first camera 106-1 and the second camera 106-2, to enable selection of the first camera 106-1 and the second camera 106-2 as an initial camera 106 to which the communication device 126 is provided access to respective current video 112 and respective historical video 118.

Alternatively, when the predetermined user gesture is detected in video 112 from only one of the cameras 106 within the geofence 408, the example shown in FIG. 6 may be omitted.

With attention next directed to FIG. 7, which is understood to follow from FIG. 6 and/or FIG. 5 (e.g., when the predetermined user gesture is detected in video 112 from only one of the cameras 106 within the geofence 408, such as the first camera 106-1), the central computing device 102 provides the credentials 404 to the first computing device 104-1 associated with the selected first camera 106-1, and/or associated with video 112-1 at which the predetermined user gesture was detected. Providing the credentials 404 to the first computing device 104-1 is understood to configure (e.g., at the block 308 of the method 300), the first camera 106-1 to be accessible by the communication device 126.

Attention is next directed to FIG. 8, which is understood to follow from FIG. 7, and which depicts the central computing device 102 receiving the current first video 112-1 and the first electronic map 120-1 from the first computing device 104-1. For example, the current first video 112-1 and the first electronic map 120-1 may be requested and/or provided by the first computing device 104-1 in response to receiving the credentials 404.

Furthermore, as depicted in FIG. 8, the user 128 may begin to walk towards the second camera 106-2.

From the electronic map 122 and the first electronic map 120-1, the central computing device 102 generates an interactive electronic map 802 and provides the interactive electronic map 802 to the communication device 126. The communication device 126 provides the interactive electronic map 802 at the GUI 140, for example with the communication device 126 and the display screen 134 rotated to a landscape orientation (e.g., compared to FIG. 1, FIG. 4, FIG. 5, FIG. 6 and FIG. 7 with the communication device 126 and the display screen 134 in a portrait orientation).

As depicted at the GUI 140, the interactive electronic map 802 comprises, in the form of a circle, an indication of the first location 124-1 of the first camera 106-1 that has been configured to be accessible by the communication device 126, as well as the first electronic map 122-1, which shows indications of locations of respective cameras 106 within the first region 108-1 in the form of circles. Indeed, at the interactive electronic map 802, the depicted circles represent interactive components (e.g., electronic buttons), which, when actuated, provide the communication device 126 with access to current video and historical video of an associated camera 106. In particular, when the circle corresponding the first camera 106-1 at the first location 124-1 is actuated, the communication device 126 is provided (e.g., at the block 310 of the method 300) with access to: first current video 112-1 from the first camera 106-1; and first historical video 118-1 from the first camera 106-1 stored at one more video databases 116.

An example of actuation of a circle and/or an indication indicating location of a camera 106 is described with respect to FIGS. 11, 12 and 13.

FIG. 8 further depicts the central computing device 104-1 generating (e.g., at the block 312 of the method 300) a feature identifier 804 of the user 128 from the first video 112-1. For example, the feature identifier 804 may comprise a classifier identifying the face of the user 128, and/or any other suitable aspect of the user 128.

Attention is next directed to FIG. 9, which is understood to follow from FIG. 8, and which depicts the central computing device 102 providing the feature identifier 804 to the computing devices 104-1, 104-2 (e.g., associated with cameras 106-1, 106-2 within the geofence 408). Providing the feature identifier 804 to the computing devices 104-1, 104-2 generally configures the respective VAEs 114-1, 114-2 to detect the user 128 in respective video 112-1, 112-2. It is understood however that providing the feature identifier 804 to the first computing device 104-1 may be redundant and/or omitted as the communication device 126 is already authorized to access respective video 112, 118 thereof.

Attention is next directed to FIG. 10, which is understood to follow from FIG. 9, and which depicts the second VAE 114-2 of the second computing device 104-2 detecting the user 128 in respective second video 112-2, and responsively providing a detect indication 1002 to the central computing device 102, along with the respective second electronic map 120-2.

The central computing device 102 responsively provides, to the second computing device 104-2, the authorization credentials 404 and hence provides (e.g., at the block 314) the communication device 126 with access to respective second video 112-2, 118-2.

The central computing device 102 furthermore generates an updated interactive map 1004 including the locations of the cameras 106-1, 106-2 within the geofence 408 to which access of the communication device 126 has been authorized, the updated interactive map 1004 including the previously received first electronic map 120-1, and the presently received second electronic map 120-2. The updated interactive map 1004 is provided to the communication device 126 which provides the updated interactive map 1004 at the GUI 140. As depicted, the updated interactive map 1004 includes interactive components at camera locations (including the respective second location 124-2 of the second camera 106-2) to access respective second video 112-2, 118-2 associated with the second region 108-2. Access to such second video 112-2, 118-2 is next described.

Attention is next directed to FIG. 11, which is understood to follow from FIG. 10. At FIG. 10, the user 128 is actuating, at the GUI 130, an interactive component of the updated interactive map 1004 corresponding to the respective second location 124-2 of the second camera 106-2. In response, the GUI 140 displays further interactive components 1102, 1104 (e.g., electronic buttons) to access current second video 112-2 and historical second video 118-2 associated with the second camera 106-2. The interactive component 1104 further includes a field 1106 for receiving a date and/or time of the historical video 118-2 (e.g., as depicted “1 pm” such as 1 pm on the present day). For example, the user 128 may operate the communication device 126 to enter a date and/or time in the field 1106.

In response to one or more of the interactive components 1102, 1104 being actuated, the communication device 126 transmits one or more respective requests 1108 for respective second video 112-2, 118-2, for example to the second computing device 104-2. As the second computing device 104-2 has received the credentials 404, which are provided with the one or more respective requests 1108, the second computing device 104-2 grants access to the respective second video 112-2, 118-2. For example, the second computing device 104-2 may verify that the credentials 404 received with the requests 1108 match the credentials 404 received from the central computing device 102, adding an additional layer of security to accessing the respective second video 112-2, 118-2. While as depicted the one or more respective requests 1108 are provided directly to the second computing device 104-2 from the communication device 126, communication between the communication device 126 and the second computing device 104-2 may occur via the central computing device 102.

With attention next directed to FIG. 12, which is understood to follow from FIG. 11, the second computing device 104-2 provides the requested video 112-2, 118-2 to the communication device 126 (e.g., directly, or via the central computing device 102), and the GUI 140 displays and/or renders the second video 112-2, 118-2 in respective windows. In particular the current second video 112-2 is streamed to the communication device 126 and shown in the GUI 140 in a respective window. The GUI 140 is furthermore programmed to ensure that the windows showing the second video 112-2, 118-2 do not overlap. While suitable controls for controlling and/or playing the video 112-2, 118-2 are not depicted, such controls may nonetheless be provided at the GUI 140 (e.g., including, but not limited to, a pause control, a resume control, a forward and/or fast forward control, a reverse and/or fast reverse control, and the like, amongst other possibilities). The user 128 may hence review the second video 112-2, 118-2 to assist with responding to an incident to which the user 128 was dispatched, and the like.

It is furthermore understood that the second computing device 104-2 provides the second video 112-2, 118-2 to the communication device 126 only when: the credentials 404 are verified; and the user 128 is identified in the second video 112-2. As such access to the second video 112-2, 118-2 may occur only after: the central computing device 102 verifies the credentials 404; the second computing device 104-2 verifies the credentials 404; and the second computing device 104-2 identifies the user 128 in the second video 112-2 using the feature identifier 804.

Attention is next directed to FIG. 13, which is understood to follow from FIG. 12. At FIG. 13, the user 128 continues to walk towards the second camera 106-2 and the third cameras 106-3, and the communication device 126 provides one or more updated locations 1302 thereof to the central computing device 102 (e.g., via the location determining device 136, not depicted).

From the one or more updated locations 1302, the central computing device 102 may predict a path 1304 of the user 128. For example, as depicted, the one or more updated locations 1302 are shown on the electronic map 122 along with the previous location 406, and the central computing device 102 predicts that the path 1304 of the user 128 will include a location 1306 on a line that represents the path 1304 on the electronic map 122, that is adjacent the location 124-3 of the third camera 106-3. As such, the central computing device 102 extends the geofence 408 along the path 1304 and, as depicted, the extended geofence 408 is understood to include the location 124-3 of the third camera 106-3. The geofence 408 may be extended in any suitable manner, for example to extend 10 m, 20 m, 30 m, or any other suitable distance along the path 1304.

As the third camera 106-3 is now inside the extended geofence 408, the central computing device 102 provides, to the associated third computing device 104-3, the authorization credentials 404 and the feature identifier 804. Hence, access by the communication device 126 to the third camera 106-3 is authorized, and the associated VAE 114-3 is configured to detect the user 128. However, similar to as described with respect to the second computing device 104-2 and the second camera 106-2, the feature identifier 804 may be first provided to the associated third computing device 104-3 and the authorization credentials 404 may be provided upon the user 128 being detected in the third video 113-3 via the VAE 114-3 and the feature identifier 804.

Furthermore, with reference to FIG. 14, the third computing device 104-3 may further provide the respective electronic map 120-3 to the central computing device 102 and to the central computing device 102 may again generate an updated electronic map 1402 similar to the updated interactive electronic map 1004, for example from the maps 120-1, 120-2, 120-3 and the electronic map 122 including indications of all the cameras 106 within the extended geofence 408. The updated electronic map 1402 is provided to the communication device 126, and the updated electronic map 1402 is displayed in the GUI 140. As depicted at the GUI 140, the updated electronic map 1402 now includes the all the maps 120-1, 120-2, 120-3 and interactive components (e.g., the circles) for accessing video of respective cameras 106.

Indeed, while not depicted, the GUI 140 may include navigation components for switching between the various views of the GUI 140 (e.g., the map views of FIGS. 8 to 11, and FIG. 14 and the video rendering view of FIGS. 12 and 13). Alternatively, or in addition, both the video rendering view of FIG. 12 and FIG. 13 (which may include showing only one of a current video 112 or an historical video 118) and the map view of FIG. 8 to FIG. 11, and FIG. 14 may be provided at the display screen 134 at the same time, with controls to expand or contract a given view and/or to replace a given view with the other view, and/or vice versa.

Furthermore, the map views may be replaced with any suitable graphical and/or textual interactive components for accessing video from respective cameras 106.

Hence, in this manner, once the predetermined user gesture is detected in video 112, as the user 128 walk around the premises 110, the communication device 126 may be provided with access to video 112, 118 associated with cameras 106 at which the user 128 is detected (e.g., in respective current video 112), for example without having to request access to video 112, 118 associated with cameras 106 on a one by one basis. The communication device 126 is further prevented from accessing to respective video 112, 118 associated with cameras 106 at which the user 128 is not detected.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot reduce bandwidth usage, cannot generate a GUI programmed for certain features, cannot generate an interactive electronic map, cannot authorize access using credentials, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions and/or program code (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions and/or program code, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at one or more computing devices, an indication that a quick access camera mode (QAC) has been enabled at a communication device, the one or more computing devices communicatively coupled with a plurality of cameras from different camera systems;
determining, at the one or more computing devices, a location of the communication device;
establishing, via the one or more computing devices, a geofence around the location of the communication device, the geofence encompassing two or more cameras of the plurality of cameras;
configuring, via the one or more computing devices, a first camera within the geofence to be accessible by the communication device in response to a predetermined user gesture detected in first images from the first camera, the first camera associated with first camera system;
in response to detecting the predetermined user gesture, providing, via the one or more computing devices, the communication device with access to: first current video from the first camera; and first historical video from the first camera stored at one more video databases;
generating, via the one or more computing device, from the first current video from the first camera, a feature identifier of a user of the communication device;
in response to detecting the feature identifier in second current video from a second camera, of the plurality of cameras, within the geofence, providing, via the one or more computing devices, the communication device with access to: the second current video from the second camera; and second historical video from the second camera stored at the one more video databases, the second camera associated with a second camera system.

2. The method of claim 1, further comprising:
in response to detecting the predetermined user gesture in both the first images from the first camera and second images from the second camera, providing, to the communication device, video from, or respective indications of, both the first camera and the second camera, to enable selection of the first camera or the second camera as an initial camera to which the communication devices is provided access to respective current video and respective historical video.

3. The method of claim 1, further comprising:
in response to detecting the predetermined user gesture in the first images from the first camera, automatically authorizing, via the one or more computing devices, access by the communication device to respective video associated with all of the plurality of cameras located within the geofence.

4. The method of claim 1, wherein configuring the first camera within the geofence to be accessible by the communication device in response to the predetermined user gesture detected in the images from the first camera occurs further in response to:
receiving, from the communication device, authorization credentials.

5. The method of claim 1, further comprising:
determining a path of the user relative to the geofence using locations of the communication device, the locations one or more of: received from the communication device; and determined from respective video from the first camera and the second camera; and
extending the geofence, based on the path, to encompass one or more further cameras of the plurality of cameras.

6. The method of claim 1, further comprising:
determining a path of the user relative to the geofence;
extending the geofence, based on the path, to encompass one or more further cameras of the plurality of cameras; and
searching for the feature identifier in respective current video from the one or more further cameras, of the plurality of cameras, to further provide the communication device with access to: the respective current video from the one or more further cameras of the plurality of cameras; and respective historical video from the one or more further cameras, of the plurality of cameras, stored at one more video databases.

7. The method of claim 1, further comprising:
determining a path of the user relative to the geofence;
extending the geofence, based on the path, to encompass at least a third camera of the plurality of cameras; and
in response to detecting the feature identifier in third current video from the third camera, providing the communication device with access to: the third current video from the third camera; and third historical video from the third camera stored at the one more video databases.

8. The method of claim 1, further comprising:
determining a path of the user relative to the geofence;
extending the geofence; and
automatically authorizing, via the one or more computing devices, access by the communication device to respective video associated with all of the plurality of cameras located within the geofence as extended.

9. The method of claim 1, further comprising:
providing, to the communication device, an electronic map showing: respective locations of the two or more cameras of the plurality of cameras; and a floorplan of at least a portion of a premises associated with the two or more cameras, wherein the respective locations of the two or more cameras are provided as selectable icons that, when selected at the communication device, cause an indication of selection to be received at the one or more computing devices, which responsively provides access to respective historical video of an associated camera.

10. The method of claim 1, further comprising:
providing, to the communication device, an electronic map showing: respective locations of one or more cameras of the plurality of cameras; and a floorplan of at least a portion of a premises associated with the one or more cameras; and,
in response to the geofence being extended to include one or more further cameras, of the plurality of cameras, providing, to the communication device, an updated electronic map showing: the respective locations of the one or more cameras and the one or more further cameras, of the plurality of cameras; and an updated floorplan of at least an updated portion of the premises associated with the one or more cameras and the one or more further cameras.

11. A computing device comprising:
a communication interface;
a controller communicatively coupled with a plurality of cameras from different camera systems; and
a computer-readable storage medium having stored thereon program instructions that, when executed by the controller, cause the controller to perform a set of operations comprising:
receiving an indication that a quick access camera mode (QAC) has been enabled at a communication device;
determining a location of the communication device;
establishing a geofence around the location of the communication device, the geofence encompassing two or more cameras of the plurality of cameras;
configuring a first camera within the geofence to be accessible by the communication device in response to a predetermined user gesture detected in first images from the first camera, the first camera associated with first camera system;
in response to detecting the predetermined user gesture, providing, via the communication interface, the communication device with access to: first current video from the first camera; and first historical video from the first camera stored at one more video databases;
generating, via the one or more computing device, from the first current video from the first camera, a feature identifier of a user of the communication device;
in response to detecting the feature identifier in second current video from a second camera, of the plurality of cameras, within the geofence, providing the communication device with access to: the second current video from the second camera; and second historical video from the second camera stored at the one more video databases, the second camera associated with a second camera system.

12. The computing device of claim 11, wherein the set of operations further comprises:
in response to detecting the predetermined user gesture in both the first images from the first camera and second images from the second camera, providing, to the communication device, video from, or respective indications of, both the first camera and the second camera, to enable selection of the first camera or the second camera as an initial camera to which the communication devices is provided access to respective current video and respective historical video.

13. The computing device of claim 11, wherein the set of operations further comprises:
in response to detecting the predetermined user gesture in the first images from the first camera, automatically authorizing access by the communication device to respective video associated with all of the plurality of cameras located within the geofence.

14. The method of claim 1, wherein the set of operations further comprises: configuring the first camera within the geofence to be accessible by the communication device in response to the predetermined user gesture detected in the images from the first camera further in response to:
receiving, from the communication device, authorization credentials.

15. The computing device of claim 11, wherein the set of operations further comprises:
determining a path of the user relative to the geofence using locations of the communication device, the locations one or more of: received from the communication device; and determined from respective video from the first camera and the second camera; and
extending the geofence, based on the path, to encompass one or more further cameras of the plurality of cameras.

16. The computing device of claim 11, wherein the set of operations further comprises:
determining a path of the user relative to the geofence;
extending the geofence, based on the path, to encompass one or more further cameras of the plurality of cameras; and
searching for the feature identifier in respective current video from the one or more further cameras, of the plurality of cameras, to further provide the communication device with access to: the respective current video from the one or more further cameras of the plurality of cameras; and respective historical video from the one or more further cameras, of the plurality of cameras, stored at one more video databases.

17. The computing device of claim 11, wherein the set of operations further comprises:
determining a path of the user relative to the geofence;
extending the geofence, based on the path, to encompass at least a third camera of the plurality of cameras; and
in response to detecting the feature identifier in third current video from the third camera, providing the communication device with access to: the third current video from the third camera; and third historical video from the third camera stored at the one more video databases.

18. The computing device of claim 11, wherein the set of operations further comprises:
determining a path of the user relative to the geofence;
extending the geofence; and
automatically authorizing access by the communication device to respective video associated with all of the plurality of cameras located within the geofence as extended.

19. The computing device of claim 11, wherein the set of operations further comprises:
providing, to the communication device, an electronic map showing: respective locations of the two or more cameras of the plurality of cameras; and a floorplan of at least a portion of a premises associated with the two or more cameras, wherein the respective locations of the two or more cameras are provided as selectable icons that, when selected at the communication device, cause an indication of selection to be received at the computing device, which responsively provides access to respective historical video of an associated camera.

20. The computing device of claim 11, wherein the set of operations further comprises:
providing, to the communication device, an electronic map showing: respective locations of one or more cameras of the plurality of cameras; and a floorplan of at least a portion of a premises associated with the one or more cameras; and,
in response to the geofence being extended to include one or more further cameras, of the plurality of cameras, providing, to the communication device, an updated electronic map showing: the respective locations of the one or more cameras and the one or more further cameras, of the plurality of cameras; and an updated floorplan of at least an updated portion of the premises associated with the one or more cameras and the one or more further cameras.
